(19) United States
(12) Patent Application Publication
(10) Pub. No.: US 2026/0026548 A1
(43) Pub. Date: Jan. 29, 2026

(54) CARTRIDGE WITH NON-CIRCULAR CROSS-SECTION

(71) Applicant: Philip Morris Products S.A., Neuchatel (CH)

(72) Inventors: David Murray CROSS, Hertfordshire (GB); Stuart Michael Ruan JONES, Hertfordshire (GB)

(73) Assignee: Philip Morris Products S.A., Neuchatel (CH)

(21) Appl. No.: 18/993,333

(22) PCT Filed: Aug. 10, 2023
(86) PCT No.: PCT/EP2023/072203

§ 371 Date: Jan. 10, 2025

(30) Foreign Application Priority Data
Aug. 11, 2022 (EP) 22190004.6

(51) Int. Cl. A24F 40/42; A24F 7/00; A24F 40/10; A24F 40/44; A24F 40/465; A24F 40/48; H05B 6/10

(52) U.S. Cl. CPC A24F 40/42; A24F 7/00; A24F 40/10; A24F 40/44; A24F 40/465; A24F 40/48; H05B 6/108

(57) ABSTRACT

A cartridge for an aerosol-generating device is provided, the cartridge including: a longitudinal axis extending between a proximal end and a distal end of the cartridge; an inner airflow path extending between the proximal end and the distal end; a liquid storage portion configured to hold a liquid aerosol-forming substrate; and a trunk assembly circumscribing at least a portion of the inner airflow path and including a non-circular cross-section perpendicular to the longitudinal axis, the non-circular cross-section including a direction of maximum dimension, the trunk assembly further including a susceptor element having at least one planar major surface, and the susceptor element being arranged within the inner airflow path such that the at least one planar major surface of the susceptor is aligned in parallel to a plane defined by the direction of maximum dimension and the longitudinal axis.

The present disclosure relates to a cartridge for use with an aerosol-generating device. The present disclosure further relates to an aerosol-generating system comprising the cartridge and the aerosol-generating device.

It is known to provide an aerosol-generating device for generating an inhalable vapor. Such devices may heat an aerosol-forming substrate contained in a cartridge without burning the aerosol-forming substrate. The aerosol-generating device may comprise a heating arrangement. The heating arrangement may be an induction heating arrangement and may comprise an induction coil and a susceptor. The susceptor may be part of the device or may be part of the cartridge.

Upon heating to a target temperature, the aerosol-forming substrate vaporises to form an aerosol. The aerosol-forming substrate may be present in solid form or in liquid form. Liquid aerosol-forming substrate may be comprised in a liquid storage portion and may be delivered to the heating element via a capillary component.

It would be desirable to provide an aerosol-generating system with an improved energy efficiency. It would be desirable to provide an aerosol-generating system which allows to quickly heat a heating element to a target temperature.

It would be desirable to provide a cartridge which allows to efficiently supply liquid aerosol-forming substrate from a liquid storage portion towards a heating element of the cartridge.

According to an embodiment of the invention there is provided a cartridge for use with an aerosol-generating device. The cartridge may comprise a longitudinal axis extending between a proximal end and a distal end of the cartridge. The cartridge may comprise an inner airflow path extending between the proximal end and the distal end. The cartridge may comprise a liquid storage portion for holding a liquid aerosol-forming substrate. The cartridge may comprise a trunk assembly circumscribing at least a portion of the inner airflow path. The trunk assembly may comprise a non-circular cross-section perpendicular to the longitudinal axis. The non-circular cross-section may comprise a direction of maximum dimension. The trunk assembly may comprise a susceptor element having at least one planar major surface. The susceptor element may be arranged within the inner airflow path such that the at least one planar major surface of the susceptor is aligned in parallel to a plane defined by the direction of maximum dimension and the longitudinal axis.

According to an embodiment of the invention there is provided a cartridge for use with an aerosol-generating device. The cartridge comprises a longitudinal axis extending between a proximal end and a distal end of the cartridge. The cartridge comprises an inner airflow path extending between the proximal end and the distal end. The cartridge comprises a liquid storage portion for holding a liquid aerosol-forming substrate. The cartridge comprises a trunk assembly circumscribing at least a portion of the inner airflow path. At least a portion of the trunk assembly, preferably at least a distal portion of the trunk assembly, comprises a non-circular cross-section perpendicular to the longitudinal axis. The non-circular cross-section comprises a direction of maximum dimension. The trunk assembly further comprises a susceptor element having at least one planar major surface. The susceptor element is arranged within the inner airflow path such that the at least one planar major surface of the susceptor is aligned in parallel to a plane defined by the direction of maximum dimension and the longitudinal axis.

By the cartridge, an aerosol-generating system with an improved energy efficiency may be provided. By the cartridge, an aerosol-generating system which allows to quickly heat a heating element to a target temperature may be provided. A cartridge which allows to efficiently supply liquid aerosol-forming substrate from a liquid storage portion towards a heating element of the cartridge may be provided.

The trunk assembly may coaxially circumscribe the at least a portion of the inner airflow path.

The non-circular cross-section may comprise at least one straight side corresponding to a planar outer surface of the trunk assembly. The at least one straight side may be aligned in parallel to the direction of maximum dimension. The susceptor element may be arranged within the inner airflow path such that the at least one planar major surface of the susceptor element is aligned in parallel to the planar outer surface of the trunk assembly.

The non-circular cross-section may be constructed by two opposing straight sides and two opposing curved sides. The curved sides may be in the form of semicircles such that the cross-section forms a stadium shape. The non-circular cross-section may assume an oval shape. The non-circular cross-section may assume an ellipsoid shape and the direction of maximum dimension may coincide with the major axis of the ellipse.

The trunk assembly may comprise an outer tubular sleeve element circumscribing the interior components of the trunk assembly. The sleeve element may function as an outer housing of the trunk assembly. The sleeve element may function as an outer housing of at least a distal portion of the cartridge. At least a portion of the sleeve element, preferably at least a distal portion of the sleeve element, may comprise the non-circular cross-section perpendicular to the longitudinal axis with the direction of maximum dimension and the at least one planar major surface of the susceptor being aligned in parallel to the plane defined by the direction of maximum dimension and the longitudinal axis.

The trunk assembly may comprise a liquid supply channel configured to supply liquid aerosol-forming substrate from the liquid storage portion towards the susceptor element.

The liquid supply channel may comprise a first channel portion and a second channel portion. The inner airflow path and the susceptor element may be arranged between the first channel portion and the second channel portion along the direction of maximum dimension of the non-circular cross-section of the trunk assembly.

A distal end of the mouthpiece may be attached to a proximal end of the trunk assembly, preferably by ultrasonic welding.

The trunk assembly may comprise a tubular internal unit circumscribed by an outer wall of the trunk assembly. The non-circular cross-section of the trunk assembly may be defined by the outer wall of the trunk assembly.

The internal unit may comprise a tubular sealing component. The internal unit may comprise a tubular heater component. The heater component may comprise the susceptor element. The heater component may be arranged distal to the sealing component. The internal unit may comprise a tubular airflow management component. The airflow management component may be arranged distal to the heater component. The internal unit may comprise a proximal tubular sealing component, an intermediate tubular heater component comprising the susceptor element, and a distal tubular airflow management component. The sealing component, the heater component, and the airflow management component may be connected in series along the longitudinal axis.

The internal unit may coaxially circumscribe at least a portion of the inner airflow path.

A distal end of the heater component may be connected to a proximal end of the airflow management component. A proximal end of the heater component may be connected to a distal end of the sealing component.

The sealing component, the heater component, and the airflow management component may be connected by plug connections. A simple way of assembling the internal unit may be provided by plugging the sealing component, the heater component, and the airflow management component into one another.

The cartridge may comprise a tubular sleeve element circumscribing at least a portion of the internal unit. The tubular sleeve element may coaxially circumscribe at least a portion of the internal unit. The cartridge may comprise a liquid supply channel. The liquid supply channel may be arranged between the internal unit and the sleeve element. The liquid supply channel may be configured for supplying liquid from the liquid storage portion towards the susceptor element.

The liquid storage portion may circumscribe a portion of the inner airflow path. The liquid storage portion may coaxially circumscribe a portion of the inner airflow path. The liquid storage portion may be provided proximal to the internal unit with respect to the longitudinal axis of the cartridge. The liquid storage portion may be provided proximal to the sleeve element with respect to the longitudinal axis of the cartridge.

The cartridge may comprise a mouthpiece. A proximal end portion of the cartridge may be configured as a mouthpiece. The liquid storage portion may be at least partly arranged within the mouthpiece. The liquid storage portion may form part of the mouthpiece. A distal end of the mouthpiece may be attached to a proximal end of the sleeve element. The distal end of the mouthpiece may be permanently attached to the proximal end of the sleeve element. The distal end of the mouthpiece may be attached to the proximal end of the sleeve element by ultrasonic welding.

The internal unit may be axially movable with respect to the sleeve element.

The sealing component may comprise a tubular element circumscribing a portion of the inner airflow path and a proximal sealing element arranged on an outer surface of the tubular element. The tubular element of the sealing component may coaxially circumscribe the portion of the inner airflow path.

The proximal sealing element may be provided as a continuous protrusion arranged circumferentially around the tubular element of the sealing component.

The proximal sealing element may be provided as a seal lip. The seal lip may comprise a hook-like profile.

The proximal sealing element may be provided as an O-ring. The tubular element may comprise a guiding means to hold the O-ring in position. The O-ring may exhibit a compression ratio of between 15 percent and 25 percent, preferably of between 18 percent and 22 percent, more preferably of about 20 percent, when the internal unit is in the blocking position.

The proximal sealing element may comprise polymeric material, preferably elastomeric material. The elastomeric material may be selected from one or more of polytetrafluoroethylene (PTFE), Nitrile, Neoprene, ethylene propylene diene monomer rubber (EPDM Rubber), Fluorocarbon, silicone, low density polyethylene (LDPE), and polypropylene (PP). The elastomeric material may comprise soft polymers, for example one or both of LDPE and PP. The elastomeric material may comprise thermoplastic elastomers (TPE). The TPE may have a hardness from between 30 to 90 Shore A.

The tubular element of the sealing component and the proximal sealing element may be made from the same material. The tubular element of the sealing component and the proximal sealing element may be configured as a monolithic piece.

The internal unit may be axially movable with respect to the sleeve element from a blocking position to an open position. In the blocking position, the proximal sealing element may be arranged to block a fluid connection between the liquid storage portion and the liquid supply channel. In the open position the proximal sealing element may be moved to open a fluid connection between the liquid storage portion and the liquid supply channel.

The blocking position may be a pre-use configuration of a fresh cartridge.

In the blocking position, the liquid storage portion may be sealed by the proximal sealing element. Leakage of aerosol-forming substrate may be further reduced or avoided. Contact to oxygen of aerosol-forming substrate may be further reduced or avoided. A cartridge which may provide a longer shelf life is provided.

In the blocking position, the susceptor element may be fluidly isolated from the liquid aerosol-forming substrate in the liquid storage portion by the proximal sealing element. Oxidation of the susceptor element of the cartridge prior to the first use may be further reduced or prevented prior to the first use of the cartridge.

In the blocking position, the proximal sealing element may be in contact with an internal wall of the cartridge to block a fluid connection between the liquid storage portion and the liquid supply channel. In the open position, the proximal sealing element may be moved away from the internal wall of the cartridge to open a fluid connection between the liquid storage portion and the liquid supply channel. The internal wall of the cartridge may be an internal wall of the trunk assembly. The internal wall of the cartridge may be an internal wall of the sleeve element. The internal wall of the cartridge may be an internal wall of the mouthpiece.

The cartridge may be configured to automatically move the internal unit from the blocking position to the open position on engaging the cartridge with an aerosol-generating device. Thereby the cartridge may be comfortably handled by a user.

The cartridge may comprise a pushing means provided at the distal end of the cartridge. The pushing means may be directly connected to the internal unit. The pushing means may be part of the internal unit. The pushing means may be part a distal end face of the airflow management component. The cartridge may be configured such that the internal unit is moved from the blocking position in the open position by pushing the pushing means towards the proximal end of the cartridge on engaging the cartridge with the aerosol-generating device.

The cartridge may be configured such that the internal unit remains in the open position when the cartridge is detached from the aerosol-generating device. This may allow a user to easily visually verify whether a given cartridge is a fresh cartridge or a used cartridge.

The internal unit may remain coupled to the rest of the cartridge in both the blocking position and the open position.

The heater component may comprise a fluid permeable wall portion arranged to allow migration of liquid aerosol-forming substrate from the liquid supply channel to the inner airflow path. The fluid permeable wall portion may be arranged to allow migration of liquid aerosol-forming substrate towards the susceptor element in the inner airflow path. The fluid permeable wall portion may be a porous or perforated wall portion. The fluid permeable wall portion may be formed by two slits in opposing sidewalls of the tubular heater component. The susceptor element may be located in the inner airflow path between the two slits.

The cartridge may comprise a wick element arranged to transfer liquid aerosol-forming substrate from the liquid supply channel towards the susceptor element. The cartridge may comprise a wick element arranged to transfer liquid aerosol-forming substrate from the liquid supply channel to the susceptor element. The heater component may comprise the wick element. The wick element may comprise one or more of a cotton-based material, a porous ceramic-based material, and a porous graphite-based material.

The fluid permeable wall portion of the heater component may be formed by two slits in opposing sidewalls of the tubular heater component and the wick element may extend between and through the slits. A center portion of the wick element may be arranged within the inner airflow path and may be sandwiched by the susceptor element. The susceptor element sandwiching the wick element may describe a U-shape. The susceptor element may comprise two substantially planar portions sandwiching the wick element. The wick element may have a sheet-like shape.

The airflow management component may comprise a tubular element circumscribing a portion of the inner airflow path and a retention element provided at the distal end of the airflow management component. The retention element may help reducing or avoiding leakage of liquid aerosol-forming substrate or liquid condensates.

The tubular element of the airflow management component may be a tubular sidewall. The tubular element of the airflow management component may coaxially circumscribe the portion of the inner airflow path.

The retention element may comprise a closed distal end wall of the airflow management component. Such a closed distal end wall may provide a retention element which is particularly well suited for receiving liquid aerosol-forming substrate from one or both of the susceptor element and the inner airflow path of the cartridge. The retention element may be formed as a trough. This may enable the retention element to collect and receive larger quantities of liquid aerosol-forming substrate.

The tubular sidewall of the airflow management component may comprise at least one air inlet for providing air into the inner airflow path. The at least one air inlet may be located spaced apart from the distal end of the airflow management component.

The airflow management component may comprise an airflow directing element arranged in the inner airflow path. The airflow directing element may be configured for directing an airflow over the susceptor element. The airflow directing element may comprise a partition wall element extending between opposing wall portions of the tubular sidewall of the airflow management component.

The airflow management component may comprise a distal sealing element arranged on an outer surface of the tubular element or the tubular sidewall of the airflow management component. The distal sealing element may be configured for sealing a distal end of the liquid supply channel.

A proximal portion of the cartridge may have an oval cross-section perpendicular to the longitudinal axis of the cartridge. The oval cross-section may taper towards the proximal end.

A distal end portion of the cartridge may be configured for engaging with the aerosol-generating device. A distal end portion of the cartridge may be configured for being inserted into a cavity or heating chamber of the aerosol-generating device. The distal end portion of the cartridge may comprise connection means configured to be releasably connectable to the aerosol-generating device. The connection means may comprise magnetic connection means.

The distal end of the cartridge may be configured for engaging with the aerosol-generating device. The distal end of the cartridge may be configured for being inserted into a cavity of the aerosol-generating device. The distal end of the cartridge may comprise connection means configured to be releasably connectable to the aerosol-generating device. The connection means may be mechanical. The connection means may comprise one or more springs. The one or more springs may be made of plastic material or metallic material or a combination thereof. The connection means may comprise magnetic connection means.

The proximal end of the cartridge may be a mouth end. The proximal end of the cartridge may comprise a mouthpiece. The proximal end of the cartridge may comprise an air outlet.

According to an embodiment of the invention there is provided an aerosol-generating system comprising a cartridge as described herein and an aerosol-generating device. The aerosol-generating device comprises a cavity arranged for receiving at least a distal portion of the cartridge. The aerosol-generating device comprises one or more inductor coils. The cavity is at least partly circumscribed by the one or more inductor coils. The cavity may be at least partly coaxially circumscribed by the one or more inductor coils. An aerosol-generating system with a compact design is provided.

The aerosol-generating device may comprise a pin element. The pin element may protrude from a distal end face of the cavity. The pin element may be a spring-loaded pin. The pin element may be a rigid pin. The pin element may be arranged to push against the distal end of the cartridge when the cartridge is inserted into the cavity. The pin element may be arranged to push against the distal end of the internal unit of the cartridge when the cartridge is inserted into the cavity. This may allow the internal unit of the cartridge to be axially moved with respect to the sleeve element in order to open the liquid supply channel for fluid connection between the liquid storage portion and the liquid supply channel. The pin element may be arranged to push the proximal sealing element of the internal unit from the blocking position into the open position, when the cartridge is inserted into the cavity.

When purchasing a fresh cartridge, the distal end of the internal unit of the fresh cartridge may protrude from the sleeve element of the cartridge. In this position, the internal unit may be in the blocking position with respect to the sleeve element. This may block a fluid connection between the liquid storage portion and the liquid supply channel before use and before the cartridge is inserted into the cavity of the aerosol-generating device.

As used herein, the term ‘parallel’ means that a maximum angle between two parallel planes and/or directions is less than 20 degrees, preferably less than 15 degrees, more preferably less than 10 degrees, more preferably less than 5 degrees, more preferably less than 2 degrees, more preferably less than 1 degree.

A maximum angle between a planar susceptor surface being parallel to the direction of maximum dimension is less than 20 degrees, preferably less than 15 degrees, more preferably less than 10 degrees, more preferably less than 5 degrees, more preferably less than 2 degrees, more preferably less than 1 degree.

As used herein, the term ‘direction of maximum dimension’ refers to a direction along a longest diameter of the two-dimensional shape defined by the non-circular cross-section. For example, when the non-circular cross-section is in the shape of an ellipsoid, the direction of maximum dimension coincides with the major axis of the ellipse. The direction of maximum dimension may also be referred to as direction of maximum expansion.

As used herein, the terms ‘tubular’, ‘tubular unit’, ‘tubular component’, ‘tubular element’, and ‘tubular shape’ refer to three-dimensional objects and three-dimensional geometric shapes comprising a bottom basal plane, a top basal plane, and a sidewall circumscribing a hollow interior, the sidewall being arranged between the bottom basal plane and the top basal plane. The sidewall extends along a longitudinal axis of the tubular element between the bottom basal plane and the top basal plane. The longitudinal axis may be perpendicular to one or both of the bottom basal plane and the top basal plane.

A bottom base of the tubular element lies within the bottom basal plane. A top base of the tubular element lies within the top basal plane. A cross-sectional shape of one or both of the bottom and top bases may be circular. A cross-sectional shape of one or both of the bottom and top bases may be non-circular, for example elliptic, stadium-shaped, or rectangular. One or both of the bottom base and the top base may be open.

The tubular element may have the shape of a right circular hollow cylinder. The tubular element may have the shape of a non-circular hollow cylinder, for example an elliptic hollow cylinder, or a stadium-shaped hollow cylinder. The tubular element may have the shape of a hollow cuboid.

The longitudinal axis of the tubular element may be arranged in parallel to the longitudinal axis of the cartridge. A longitudinal center axis of the tubular element may coincide with a longitudinal center axis of the cartridge.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in liquid form. The terms ‘aerosol’ and ‘vapor’ are used synonymously.

The aerosol-forming substrate may be part of a cartridge. The aerosol-forming substrate may be part of the liquid held in the liquid storage portion of the cartridge. The liquid storage portion may contain a liquid aerosol-forming substrate.

Preferably, a liquid nicotine or flavor/flavorant containing aerosol-forming substrate may be employed in the liquid storage portion of the cartridge.

The aerosol-forming substrate may comprise nicotine.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol. Preferably, the aerosol former is glycerine.

As used herein, the term ‘cartridge’ refers to an article comprising an aerosol-forming substrate that is capable of releasing volatile compounds that can form an aerosol. For example, a cartridge may be an article that generates an aerosol that is directly inhalable by the user drawing or puffing on a mouthpiece at a proximal or user-end of the device or at a mouthpiece of the cartridge itself. A cartridge may be disposable. A cartridge may be reusable. A cartridge may be refillable. The cartridge may be insertable into a cavity of the aerosol-generating device.

As used herein, the term ‘liquid storage portion’ refers to a storage portion comprising an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular. The liquid storage portion may form part of the cartridge.

As used herein, the term ‘aerosol-generating device’ refers to a device that interacts with a cartridge to generate an aerosol.

As used herein, the term ‘aerosol-generating system’ refers to the combination of an aerosol-generating device with a cartridge. In the system, the aerosol-generating device and the cartridge cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimeters and 150 millimeters. The aerosol-generating device may have an external diameter between 5 millimeters and 30 millimeters.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the cartridge or aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the terms ‘upstream’ and ‘downstream’ are used to describe the relative positions of components, or portions of components, of the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or cartridge. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to the susceptor element of the cartridge. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. For example, the susceptor material may comprise metallic tracks formed on an outer surface of a ceramic core or substrate.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may comprise a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first induction coil and to the second induction coil. The controller may be configured to control the electrical current supplied to the induction coil(s), and thus the magnetic field strength generated by the induction coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

### Example E1

A cartridge for use with an aerosol-generating device, comprising
a longitudinal axis extending between a proximal end and a distal end of the cartridge;
an inner airflow path extending between the proximal end and the distal end;
a liquid storage portion for holding a liquid aerosol-forming substrate; and
a trunk assembly circumscribing at least a portion of the inner airflow path and comprising a non-circular cross-section perpendicular to the longitudinal axis,
wherein the non-circular cross-section comprises a direction of maximum dimension,
wherein the trunk assembly further comprises a susceptor element having at least one planar major surface, and
wherein the susceptor element is arranged within the inner airflow path such that the at least one planar major surface of the susceptor is aligned in parallel to a plane defined by the direction of maximum dimension and the longitudinal axis.

### Example E2

The cartridge according to Example E1, wherein the non-circular cross-section comprises at least one straight side corresponding to a planar outer surface of the trunk assembly, and
wherein the susceptor element is arranged within the inner airflow path such that the at least one planar major surface of the susceptor element is aligned in parallel to the planar outer surface of the trunk assembly.

### Example E3

The cartridge according to Example E2, wherein the non-circular cross-section is constructed by two opposing straight sides and two opposing curved sides.

Example E4

The cartridge according to Example E3, wherein the curved sides are in the form of semicircles such that the cross-section forms a stadium shape.

Example E5

The cartridge according to Example E1, wherein the non-circular cross-section assumes an oval shape.

Example E6

The cartridge according to Example E5, wherein the non-circular cross-section assumes an ellipsoid shape, and wherein the direction of maximum dimension coincides with the major axis of the ellipse.

Example E7

The cartridge according to any of the preceding examples, wherein the trunk assembly comprises a liquid supply channel configured to supply liquid aerosol-forming substrate from the liquid storage portion towards the susceptor element.

Example E8

The cartridge according to Example E7, wherein the liquid supply channel comprises a first channel portion and a second channel portion, and wherein the inner airflow path and the susceptor element are arranged between the first channel portion and the second channel portion along the direction of maximum dimension of the non-circular cross-section of the trunk assembly.

### Example E9

The cartridge according to any of the preceding examples, wherein the liquid storage portion circumscribes a portion of the inner airflow path.

### Example E10

The cartridge according to any of the preceding examples, wherein a proximal end portion of the cartridge is configured as a mouthpiece, preferably wherein the liquid storage portion is at least partly arranged within the mouthpiece.

### Example E11

The cartridge according to Example E10, wherein a distal end of the mouthpiece is attached to a proximal end of the trunk assembly, preferably by ultrasonic welding.

### Example E12

The cartridge according to any of the preceding examples, wherein the trunk assembly comprises a tubular internal unit circumscribed by an outer wall of the trunk assembly, and wherein the non-circular cross-section of the trunk assembly is defined by the outer wall of the trunk assembly.

### Example E13

The cartridge according to Example E12, wherein the internal unit comprises, a proximal tubular sealing component, an intermediate tubular heater component comprising the susceptor element, and a distal tubular airflow management component, and
wherein the sealing component, the heater component, and the airflow management component are connected in series along the longitudinal axis.

### Example E14

The cartridge according to Example E13, wherein the heater component comprises a fluid permeable wall portion arranged to allow migration of liquid aerosol-forming substrate towards the susceptor element in the inner airflow path.

### Example E15

The cartridge according to Example E14, wherein the fluid permeable wall portion is formed by two slits in opposing sidewalls of the tubular heater component.

### Example E16

The cartridge according to Example E15, comprising a wick element arranged to transfer liquid aerosol-forming substrate to the susceptor element.

### Example E17

An aerosol-generating system, comprising
the cartridge according to any of the preceding examples; and
an aerosol-generating device comprising a heating chamber arranged for receiving at least a distal portion of the cartridge, wherein the heating chamber is at least partly circumscribed by an inductor coil.

Features described in relation to one embodiment may equally be applied to other embodiments of the invention.

The invention will be further described, by way of example only, with reference to the accompanying drawings in which:

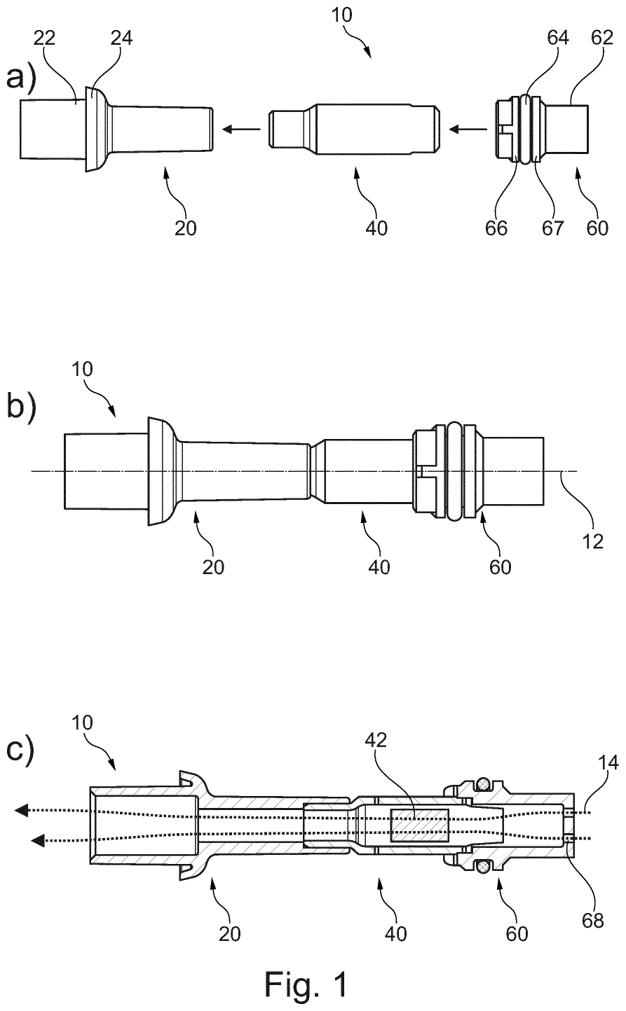

FIGS. 1a to 1c show a tubular internal unit of a cartridge for use with an aerosol-generating device;

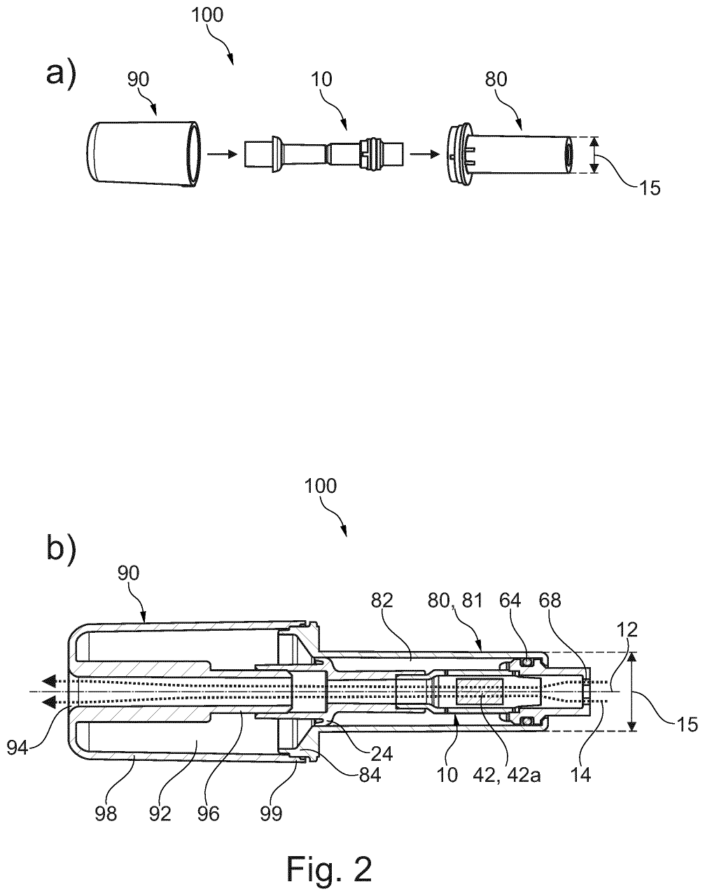

FIGS. 2a and 2b show a cartridge for use with an aerosol-generating device;

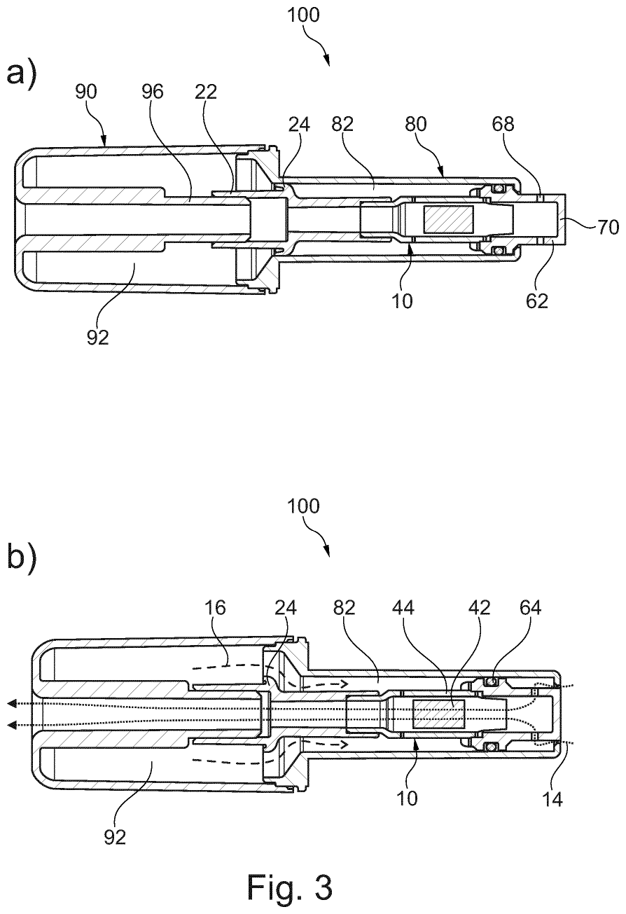

FIGS. 3a and 3b show a cartridge for use with an aerosol-generating device;

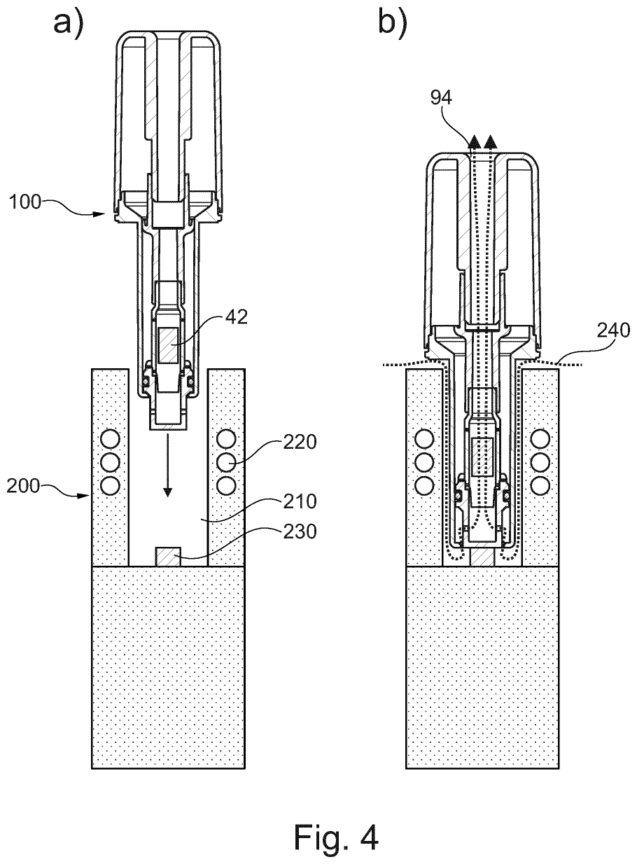

FIGS. 4a and 4b show an aerosol-generating system;

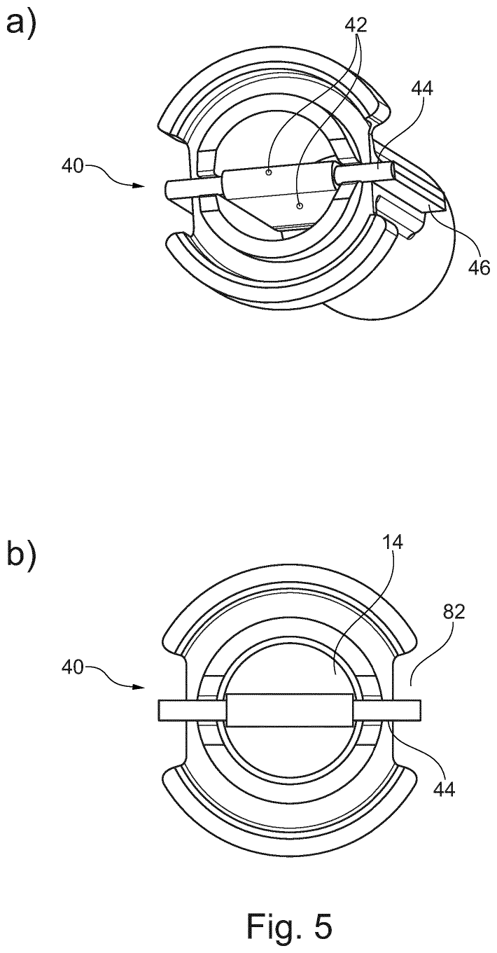

FIGS. 5a and 5b show a heater component of a cartridge for use with an aerosol-generating device;

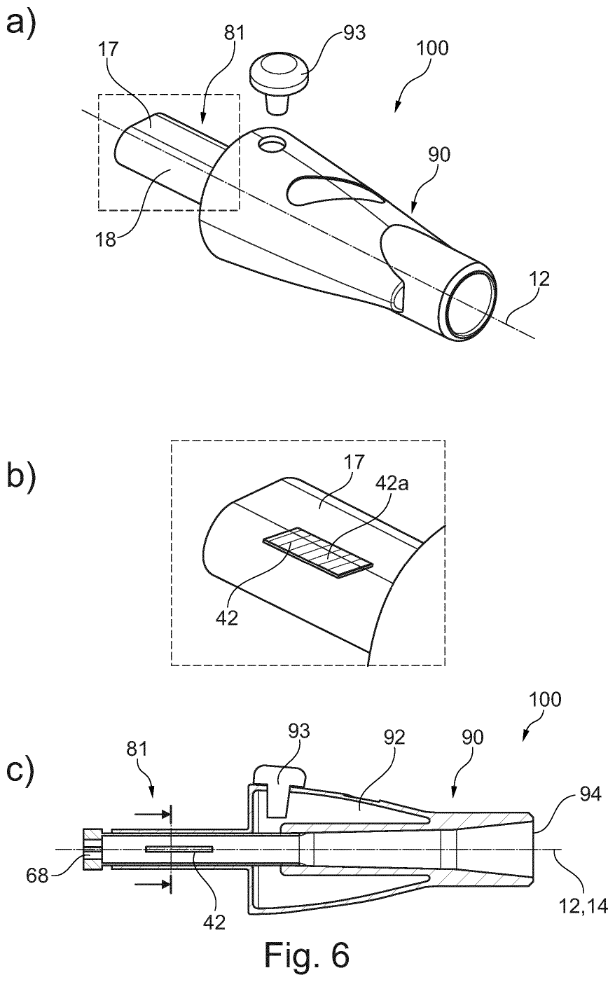

FIGS. 6a to 6c show a cartridge for an aerosol-generating device;

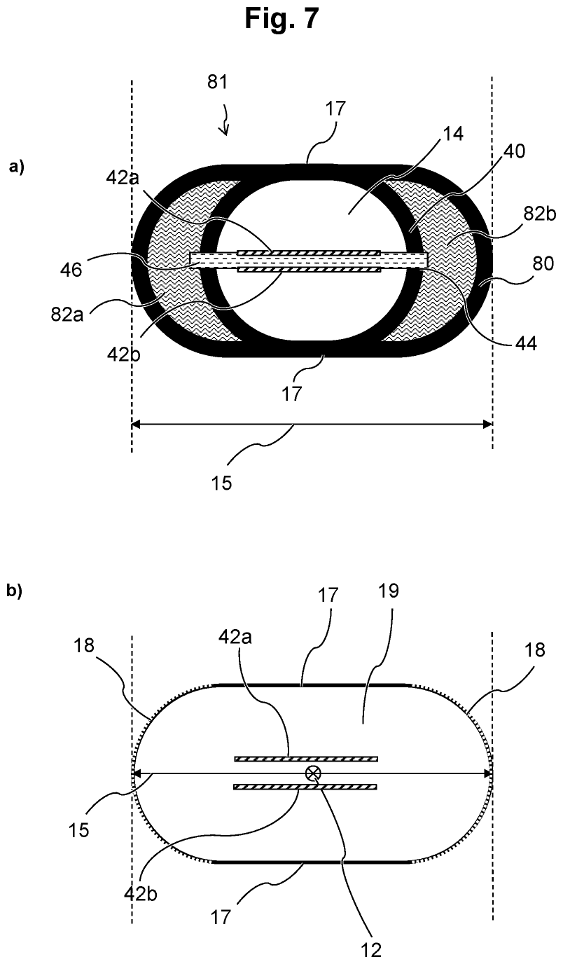

FIGS. 7a and 7b show a cartridge for an aerosol-generating device;

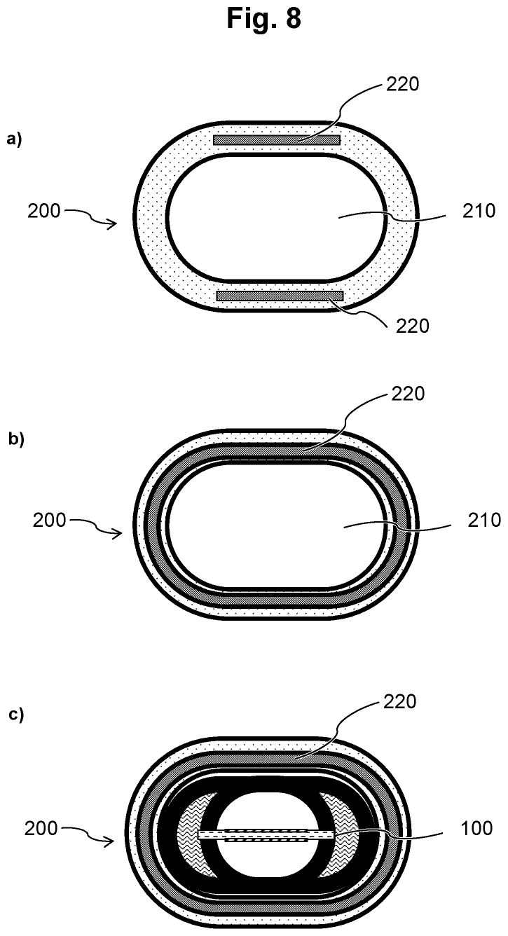

FIGS. 8a and 8b show aerosol-generating devices; and

FIG. 8c shows an aerosol-generating system.

FIG. 1a shows a tubular internal unit 10 in disassembled configuration. The internal unit 10 comprises a proximal tubular sealing component 20, an intermediate tubular heater component 40 comprising a susceptor element in its hollow interior (not shown), and a distal tubular airflow management component 60.

The sealing component 20 comprises a tubular element 22 and a proximal sealing element 24 arranged on an outer surface of the tubular element 22. The proximal sealing element 24 is provided as a continuous protrusion arranged circumferentially around the tubular element 22 of the sealing component 20. The proximal sealing element 24 is provided as a seal lip. The tubular element 22 and the proximal sealing element 24 of the sealing component 20 are formed as a monolithic piece.

The airflow management component 60 comprises a tubular sidewall 62 and a distal sealing element 64 provided as an O-ring arranged on an outer surface of the tubular sidewall 62. The O-ring is axially held in position between a first protrusion 66 and a second protrusion 67 of the airflow management component 60.

FIG. 1b shows the tubular internal unit 10 of FIG. 1a in assembled configuration. The sealing component 20, the heater component 40, and the airflow management component 60 are connected in series along a longitudinal axis 12. A distal end of the heater component 40 is plugged into proximal end of the airflow management component 60. A proximal end of the heater component 40 is plugged into a distal end of the sealing component 20. The plugging action is indicated by arrows in FIG. 1a.

FIG. 1c shows the assembled tubular internal unit 10 of FIG. 1b in cross-sectional view. The airflow management component 60 comprises air inlets 68 allowing air to enter the hollow tubular interior of the tubular internal unit 10. An inner airflow path 14 is circumscribed by the tubular internal unit 10. The inner airflow path 14 passes the susceptor 42 of the heater component 40.

FIG. 2a shows a cartridge 100 in disassembled configuration. The cartridge 100 comprises the internal unit 10 of FIGS. 1a to 1c. The cartridge 100 comprises a tubular sleeve element 80. At least a distal part of the sleeve element 81 comprises a non-circular cross-section comprising a direction of maximum dimension 15. The cartridge 100 comprises a mouthpiece 90 at a proximal end thereof.

FIG. 2b shows the cartridge 100 of FIG. 2a in assembled configuration in cross-sectional view. The tubular sleeve element 80 circumscribes a portion of the internal unit 10. A liquid supply channel 82 is formed by an empty space between the internal unit 10 and the sleeve element 80. The distal sealing element 64 of the airflow management component 60 is configured for closing and sealing a distal end of the liquid supply channel 82.

The mouthpiece 90 comprises a liquid storage portion 92 circumscribing a portion of the inner airflow path 14. The liquid storage portion 92 is provided by an empty space between an inner tubular wall portion 96 of the mouthpiece 90 circumscribing the inner airflow path 14 and an outer tubular wall portion 98 of the mouthpiece 90 circumscribing the liquid storage portion 92. A proximal end 94 of the mouthpiece 90 comprises an air outlet. A distal end 99 of the mouthpiece 90 is attached to a proximal end 84 of the sleeve element 80. For example, a permanent attachment may be achieved by ultrasonic welding.

A distal portion of the cartridge 100 comprising the internal unit 10 together with the tubular sleeve element 80 and the liquid supply channel 82 forms a trunk assembly 81.

The susceptor element 42 comprises at least one planar major surface 42a. The susceptor element 42 is arranged within the inner airflow path 14 such that the at least one planar major surface 42a is aligned in parallel to a plane defined by the direction of maximum dimension 15 and the longitudinal axis 12.

FIG. 3a shows a cartridge 100 being mainly identical to the cartridge 100 of FIGS. 2a and 2b with the exception that the air inlets 68 are located at a different position. In the embodiment of FIG. 3a, the air inlets 68 are located in the tubular sidewall 62 of the airflow management component 60. The air inlets 68 are thus located spaced apart from a distal end of the airflow management component 60. Thereby, the airflow management component 60 comprises a retention element 70 provided at the distal end of the airflow management component 60, wherein the retention element 70 comprises a closed distal end wall of the airflow management component 60.

The internal unit 10 is axially movable with respect to the sleeve element 80 from a blocking position shown in FIG. 3a, in which the proximal sealing element 24 is arranged to block a fluid connection between the liquid storage portion 92 and the liquid supply channel 82, to an open position shown in FIG. 3b, in which the proximal sealing element 24 is moved to open a fluid connection between the liquid storage portion 92 and the liquid supply channel 82. In the blocking position shown in FIG. 3a, the proximal sealing element 24 is in contact with an internal wall of the sleeve element 80 to block a fluid connection between the liquid storage portion 92 and the liquid supply channel 82.

In the open position shown in FIG. 3b, the proximal sealing element 24 is moved away from the internal wall to open a fluid connection between the liquid storage portion 92 and the liquid supply channel 82. In the open position shown in FIG. 3b, a liquid passageway 16 has formed, allowing liquid aerosol-forming substrate to migrate from the liquid storage portion 92 into the liquid supply channel 82. The distal sealing element 64 of the airflow management component 60 seals a distal end of the liquid supply channel 82 preventing liquid aerosol-forming substrate from exiting the liquid supply channel 82 at a distal end thereof in the open position.

A distal portion of the inner tubular wall portion 96 of the mouthpiece 90 may slide within a proximal portion of the tubular element 22 of the sealing component 20 when the internal unit 10 is axially moved from the blocking position shown in FIG. 3a to the open position shown in FIG. 3b.

The heater component 40 comprises a fluid permeable wall portion 44 arranged to allow migration of liquid aerosol-forming substrate from the liquid supply channel 82 into the inner airflow path 14 and towards the susceptor element 42.

FIGS. 4a and 4b show an aerosol-generating system in cross-sectional view. The aerosol-generating system comprises a cartridge, for example the cartridge 100 of FIGS. 2 and 3, and an aerosol-generating device 200. The aerosol-generating device 200 comprises a heating chamber 210 arranged for receiving at least a distal portion of the cartridge 100. The heating chamber 210 is at least partly circumscribed by an inductor coil 220.

The aerosol-generating device 200 comprises a pin element 230 protruding from a distal end face of the heating chamber 210. The pin element 230 is arranged to push the internal unit 10 of the cartridge 100 from the blocking position into the open position when the distal portion of the cartridge 100 is inserted into the heating chamber 210. FIG. 4b shows the configuration, where the distal portion of the cartridge 100 has been inserted into the heating chamber 210 and the internal unit 10 is in the open position. Consequently, liquid aerosol-forming substrate may migrate towards the susceptor 42.

Further, with the distal portion of the cartridge 100 being inserted into the heating chamber 210 as shown in FIG. 4b, the susceptor 42 of the cartridge 100 is placed within the heating chamber 210 such that an alternating electric current applied to the inductor coil 220 creates an alternating magnetic field which induces an electric current in the susceptor 42 to heat the susceptor 42.

Ambient air may enter the aerosol-generating system via a gap between the cartridge 100 and the aerosol-generating device 200. Alternatively or in addition, the aerosol-generating device 200 may comprise air inlets (not shown) in fluid connection with the heating chamber 210.

The airflow route 240 is shown as dotted lines in FIG. 4b. Liquid aerosol-forming substrate located in proximity to, or in contact with, the heated susceptor 42 may be volatized due to the elevated temperature in the area of the susceptor 42. Volatized material may be taken up by the airflow and may travel downstream along the airflow route 240 and through the air outlet at the proximal end 94 of the cartridge 100 where a ripened aerosol may be inhaled by a user.

The distal end of the cartridge 100 may comprise connection means (not shown), for example magnetic connection means, configured to be releasably connectable to an aerosol-generating device 200. The aerosol-generating device 200 may comprise corresponding connection means (not shown).

FIGS. 5a and 5b show an embodiment of the heater component 40 in perspective view (FIG. 4a) and in front view (FIG. 4b). The fluid permeable wall portion 44 is formed by two slits in opposing sidewalls of the tubular heater component 40. A wick element 46 extends between and through the slits. The wick element 46 is arranged to transfer liquid aerosol-forming substrate from the liquid supply channel 82 to the susceptor element 42 when the heater component 40 is arranged within the sleeve element 80. A center portion of the wick element 46 within the inner airflow path 14 is sandwiched by the susceptor element 42 which describes a U-shape.

FIGS. 6a to 6c show a cartridge 100 for an aerosol-generating device.

FIG. 6a shows the cartridge 100 in perspective view. The cartridge 100 comprises a trunk assembly 81 and a mouthpiece 90 arranged at a proximal end of the trunk assembly 81 with respect to the longitudinal axis 12. The mouthpiece 90 comprises a removable cork 93 for refilling liquid aerosol-forming substrate. The trunk assembly 81 comprises a non-circular cross-section 19 (see FIG. 7b) perpendicular to the longitudinal axis 12. The non-circular cross-section 19 is constructed by two opposing straight sides 17 and two opposing curved sides 18 (see also FIG. 7b).

FIG. 6b shows a magnified sub-section of the cartridge 100, as indicated by a dotted rectangle in FIG. 6a. FIG. 6b shows the trunk assembly 81 in half-transparent such that a susceptor element 42 located within the trunk assembly 81 is made visible. At least a first planar major surface 42a of the susceptor element 42 is arranged in parallel to the opposing straight sides 17 of the trunk assembly 81.

FIG. 6c shows the cartridge 100 of FIG. 6a in cross-sectional view. FIG. 6c shows a configuration with the cork 93 being plugged into the mouthpiece 90 so as to close the liquid storage portion 92. The inner airflow path 14 extends generally along the longitudinal axis 12 between one or more air inlets 68 and an air outlet at the proximal end 94 of the mouthpiece 90.

FIG. 7a shows a cross-sectional view of the trunk assembly 81 of FIGS. 6a to 6c perpendicular to the longitudinal axis 10. FIG. 7b shows the same cross-sectional view as FIG. 7a, but FIG. 7b omits several details of the interior of the trunk assembly 81 for emphasizing the non-circular cross-section 19. The longitudinal axis 12 extends perpendicular to the picture plane of FIGS. 7a and 7b as indicated in FIG. 7b. The position of the cross-sectional cut of FIGS. 7a and 7b is indicated by a dotted line and two arrows in FIG. 6c. FIGS. 7a and 7b show that the cross-section of the trunk assembly 81 has a stadium shape with a direction of maximum dimension 15.

FIG. 7a shows the susceptor element 42 located within the inner airflow path 14 and comprising a first planar major surface 42a and a second planar major surface 42b sandwiching a center portion of a wick element 46. A fluid permeable wall portion 44 is formed by two slits in opposing sidewalls of a tubular heater component 40 of the trunk assembly 81. The wick element 46 extends between and through the two slits. The wick element 46 is arranged to transfer liquid aerosol-forming substrate from first and second opposing half-moon-shaped portions of a liquid supply channel 82a, 82b towards the susceptor element 42.

The trunk assembly 81 comprises a tubular heater component 40 circumscribed by an outer wall of a sleeve element 80 of the trunk assembly 81. The tubular heater component 40 may form part of a tubular internal unit 10 as described herein which, optionally, may be arranged to be axially movable within the sleeve element 80.

As best shown in FIG. 7a together with FIG. 7b, the inner airflow path 14 and the susceptor element 42 with its major surfaces 42a, 42b are arranged between the first channel portion 82a and the second channel portion 82b along the direction of maximum dimension 15 of the non-circular cross-section 19 of the trunk assembly 81. The non-circular cross-section 19 of the trunk assembly 81 is defined by the sleeve element 80 which represents the outer wall of the trunk assembly 81.

As further shown in FIGS. 7a and 7b, the susceptor element 42 is arranged within the inner airflow path 14 such that the first and second planar major surfaces 42a, 42b are aligned in parallel to a plane defined by the direction of maximum dimension 15 and the longitudinal axis 12.

As shown in detail in FIG. 7b, the non-circular cross-section 19 is constructed by two opposing straight sides 17 and two opposing curved sides 18. The curved sides 18 are in the form of semicircles such that the cross-section forms a stadium shape.

As shown in FIG. 7a, the two straight sides 17 correspond to a planar outer surface 17 of the sleeve element 80 which is part of the outer surface of the trunk assembly 81 (see also FIG. 6a). The susceptor element 42 is arranged within the inner airflow path 14 such that the first and second planar major surfaces of the susceptor 42a, 42b are aligned in parallel to the planar outer surface 17 of the trunk assembly 81.

FIG. 8a shows a cross-sectional view of an aerosol-generating device 200 perpendicular to its longitudinal axis. The longitudinal axis of the device 200 thus extends perpendicular to the picture plane. The cross-sectional view is shown at a longitudinal position of a heating chamber 210. The heating chamber 210 has a stadium shaped, non-circular cross-section. The aerosol-generating device 200 of FIG. 8a comprises two planar inductor coils 220.

FIG. 8b also shows a cross-sectional view of an aerosol-generating device 200 perpendicular to its longitudinal axis which extends perpendicular to the picture plane. The cross-sectional view is also shown at a longitudinal position of a heating chamber 210 which has a stadium shaped, non-circular cross-section. The aerosol-generating device 200 of FIG. 8b comprises an inductor coil 220 having a non-circular cross-section perpendicular to its longitudinal axis.

FIG. 8c shows a cross-sectional view of an aerosol-generating system comprising the aerosol-generating device 200 of FIG. 8b, and the cartridge 100 of FIGS. 6 and 7, wherein at least a distal portion the trunk assembly 81 of the cartridge 100 is inserted into the heating chamber 210. The non-circular cross-section 19 of the trunk assembly 81 perpendicular to the longitudinal axis 12 in conjunction with the aligned planar major surfaces 42a, 42b of the cartridge 100 allow for having only a small distance between the inductor coil 220 and the susceptor element 42 with its planar major surfaces 42a, 42b. Thereby, energy transfer from the inductor coil 220 and the susceptor 42 may be optimized. An energy efficient system may be provided. A similarly energy efficient aerosol-generating system may be provided, when the cartridge 100 of FIGS. 6 and 7 is inserted into the device 200 of FIG. 8a.

1.-15. (canceled)

16. A cartridge for an aerosol-generating device, the cartridge comprising:
a longitudinal axis extending between a proximal end and a distal end of the cartridge;
an inner airflow path extending between the proximal end and the distal end;
a liquid storage portion configured to hold a liquid aerosol-forming substrate; and
a trunk assembly circumscribing at least a portion of the inner airflow path and comprising a non-circular cross-section perpendicular to the longitudinal axis,
wherein the non-circular cross-section comprises a direction of maximum dimension,
wherein the trunk assembly further comprises a susceptor element having at least one planar major surface, and
wherein the susceptor element is arranged within the inner airflow path such that the at least one planar major surface of the susceptor is aligned in parallel to a plane defined by the direction of maximum dimension and the longitudinal axis.

17. The cartridge according to claim 16,
wherein the non-circular cross-section further comprises at least one straight side corresponding to a planar outer surface of the trunk assembly, and
wherein the susceptor element is arranged within the inner airflow path such that the at least one planar major surface of the susceptor element is aligned in parallel to the planar outer surface of the trunk assembly.

18. The cartridge according to claim 17, wherein the non-circular cross-section is constructed by two opposing straight sides and two opposing curved sides.

19. The cartridge according to claim 18, wherein the curved sides are in the form of semicircles such that the cross-section forms a stadium shape.

20. The cartridge according to claim 16, wherein the non-circular cross-section assumes an oval shape.

21. The cartridge according to claim 20,
wherein the non-circular cross-section assumes an ellipsoid shape, and
wherein the direction of maximum dimension coincides with the major axis of the ellipse.

22. The cartridge according to claim 16, wherein the trunk assembly further comprises a liquid supply channel configured to supply liquid aerosol-forming substrate from the liquid storage portion towards the susceptor element.

23. The cartridge according to claim 22,
wherein the liquid supply channel comprises a first channel portion and a second channel portion, and
wherein the inner airflow path and the susceptor element are arranged between the first channel portion and the second channel portion along the direction of maximum dimension of the non-circular cross-section of the trunk assembly.

24. The cartridge according to claim 16, wherein the liquid storage portion circumscribes a portion of the inner airflow path.

25. The cartridge according to claim 16, wherein a proximal end portion of the cartridge is configured as a mouthpiece.

26. The cartridge according to claim 25, wherein the liquid storage portion is at least partly arranged within the mouthpiece.

27. The cartridge according to claim 25, wherein a distal end of the mouthpiece is attached to a proximal end of the trunk assembly.

28. The cartridge according to claim 27, wherein the distal end of the mouthpiece is attached to the proximal end of the trunk assembly by ultrasonic welding.

29. The cartridge according to claim 16,
wherein the trunk assembly further comprises a tubular internal unit circumscribed by an outer wall of the trunk assembly, and
wherein the non-circular cross-section of the trunk assembly is defined by the outer wall of the trunk assembly.

30. The cartridge according to claim 29,
wherein the tubular internal unit comprises a proximal tubular sealing component, an intermediate tubular heater component comprising the susceptor element, and a distal tubular airflow management component, and
wherein the proximal tubular sealing component, the intermediate tubular heater component, and the distal tubular airflow management component are connected in series along the longitudinal axis.

31. The cartridge according to claim 30,
wherein the intermediate tubular heater component comprises a fluid-permeable wall portion arranged to allow migration of liquid aerosol-forming substrate towards the susceptor element in the inner airflow path, and
wherein the fluid-permeable wall portion is formed by two slits in opposing sidewalls of the intermediate tubular heater component.

32. The cartridge according to claim 30, further comprising a wick element arranged to transfer liquid aerosol-forming substrate to the susceptor element.

33. An aerosol-generating system, comprising:
the cartridge according to claim 16; and
an aerosol-generating device comprising a heating chamber configured to receive at least a distal portion of the cartridge,
wherein the heating chamber is at least partly circumscribed by an inductor coil.
